(19) United States
(12) Patent Application Publication
(10) Pub. No.: US 2009/0070584 A1
(43) Pub. Date: Mar. 12, 2009

(54) Method for Providing, Distributing and Engraving Digital Data and Associated Distribution Server

(75) Inventors: Olivier Heen, Domloup (FR); Yan-Mei Tang-Talpin, St-Gregoire (FR); Yves Maetz, Melesse (FR)

Correspondence Address: Robert D. Shedd;Thomson Licensing LLC, PO Box 5312, PRINCETON, NJ, 08543-5312, US

(73) Assignee: THOMSON LICENSING, Boulogne Billancourt (FR)

(21) Appl. No.: 12/087,404

(22) PCT Filed: Jan. 8, 2007
(86) PCT No.: PCT/FR2007/000021

§ 371 Date: Jul. 3, 2008

(30) Foreign Application Priority Data
Jan. 6, 2006 (FR) 06 00135

(51) Int. Cl. H04L 9/00

(52) U.S. Cl. 713/168

(57) ABSTRACT

The invention relates to a method for engraving digital data received from a remote server. The inventive method consists in acquiring an identifier of a secured disc used for receiving digital data, in transmitting the identifier and a digital data loading instruction to the remote server, in receiving digital date scrambled by at least one second encryption key and second encryption keys by a first encryption key and in engraving scrambled digital data and the second encryption keys on the secured disc. A providing and distributing methods and a distribution server are also disclosed.

The invention relates generally to a method for writing digital data representing multimedia content coming from a remote server onto a secure disc.

The invention also relates to a distribution method and to a method of making digital data, representing multimedia content intended to be written onto a secure disc, available.

The invention additionally relates to a server making data available.

A method for writing multimedia content onto a secure disc is known, in particular through the document US 2005/0154682. This method uses a writer suitable for extracting an encryption key that is prerecorded on the secure disc. This writer is able to control and receive multimedia content from a remote server and to scramble the multimedia content received using the extracted key and possibly additional keys received from a remote server or a trusted authority. Finally, it is suited to writing scrambled multimedia content onto the secure disc.

However, this method of writing requires the use of a particular writer. In addition this particular writer requires significant protection means as this contains a module for scrambling the digital data. Consequently, the use of this writer is expensive.

The aim of the invention is to propose a less expensive writing method in which a commercially existing writer may be used to write downloaded multimedia content.

To this end, the subject of the invention is a method for writing digital data coming from a remote content server, the digital data being written onto a secure disc by a client device, characterized in that it comprises the following steps carried out by the client device:
gathering an identifier from the secure disc, said identifier being associated with a first encryption key and with the secure disc on which the digital data are intended to be written, said identifier being specific to this secure disc and different from the identifiers associated with other secure discs;
transmitting to the content server, by means of a distribution network, the secure disc identifier and a command to download digital data intended to be written onto the secure disc;
receiving digital data scrambled by at least one second encryption key and the or each second encryption key encrypted by a first encryption key, the first encryption key being associated with the identifier in a database; and
writing the scrambled digital data and the or each encrypted second encryption key onto the secure disc.

According to particular embodiments, the writing method comprises one or more of the following features:
the identifier is printed in a way that can be read by a user on one side of the secure disc or on a document attached to the secure disc, and that the gathering step includes a step of entering the identifier by the user at the client device;
the secure disc identifier, the download command, the scrambled digital data and the or each encrypted second encryption key are transmitted only during the establishment of a secure connection;
the first encryption key is a disc key and the or each second encryption key is a title key in the sense of the CSS protection protocol; and
the first encryption key is independent of the identifier in the sense that it cannot be derived from a mathematical function applied to the identifier.

The subject of the invention is also a method for making digital data available through a remote content server to at least one client device by means of a distribution network, the digital data being intended to be written onto a secure disc by the client device, which comprises the following steps carried out by the content server:
receiving an identifier and a command to download digital data from the client device, said identifier being associated with a first encryption key and with the secure disc onto which the digital data are intended to be written, said identifier being specific to this secure disc and different from the identifiers associated with other secure discs;
acquiring the first encryption key associated with the identifier through a query to a database storing secure disc identifiers and first encryption keys associated with these identifiers;
searching for the digital data in a content database based on the download command;
generating at least one second encryption key;
scrambling the digital data searched for using the second encryption key(s) generated;
encrypting the second encryption key(s) based on the first encryption key; and
transmitting to the client device the digital data scrambled using the second encryption key(s) and the second encryption key(s) encrypted using the first encryption key.

According to one particular embodiment, the step of acquiring the first encryption key comprises the following steps:
transmitting the identifier of the secure disc to an administrative disc key server containing the storage database; and
receiving the first encryption key associated with the secure disc identifier from the administrative disc key server.

A subject of the invention is a content providing server suited to making digital data available to at least one client device by means of a distribution network, the digital data being intended to be written onto a secure disc, which comprises:
a network interface for receiving an identifier and a command to download digital data transmitted by the client device, said identifier being associated with a first encryption key and with the secure disc on which the digital data are intended to be written, said identifier being specific to this secure disc and different from the identifiers associated with other secure discs;
means for searching for digital data intended to be written in a content database based on the download command transmitted by the client device;
a random number generator suited to generating at least one second encryption key;
means for scrambling digital data intended to be written using the second encryption key(s) generated;
means for acquiring the first encryption key associated with the identifier through a query to a database storing secure disc identifiers and first encryption keys associated with these identifiers;
means of encrypting the second encryption key(s) based on the first encryption key; and
the network interface being able to transmit the digital data scrambled using the second encryption key(s) and the second encrytion key(s) encrypted using the first encryption key to the client device.

Finally, a subject of the invention is also a method for distributing digital data via a remote content server to at least one client device by means of a distribution network, the digital data being intended to be written onto a secure disc, which comprises the following steps:
gathering through the client device an identifier from the secure disc, said identifier being associated with a first encryption key and with the secure disc on which the digital data are intended to be written, said identifier being specific to this secure disc and different from the identifiers associated with other secure discs;
transmitting the secure disc identifier and a command to download digital data intended to be written onto the secure disc from the client device to the content server by means of a distribution network;
searching, by the content server, for the digital data in a content database based on the download command;
generating by the content server at least one second encryption key;
scrambling by the content server the digital data searched for using the second encryption key(s);
acquiring the first encryption key associated with the secure disc identifier through a query by the content server to a database storing secure disc identifiers and first encryption keys associated with these identifiers;
encrypting by the content server the second encryption key(s) based on the first encryption key;
transmitting from the content server to the client device the digital data scrambled using the second encryption key(s) and the second encryption key(s) encrypted using the first encryption key; and
writing onto the secure disc the scrambled digital data and the encrypted second encryption key(s) by the client device.

The invention will be better understood on reading the description to follow, provided solely by way of example and with reference to the drawings in which:

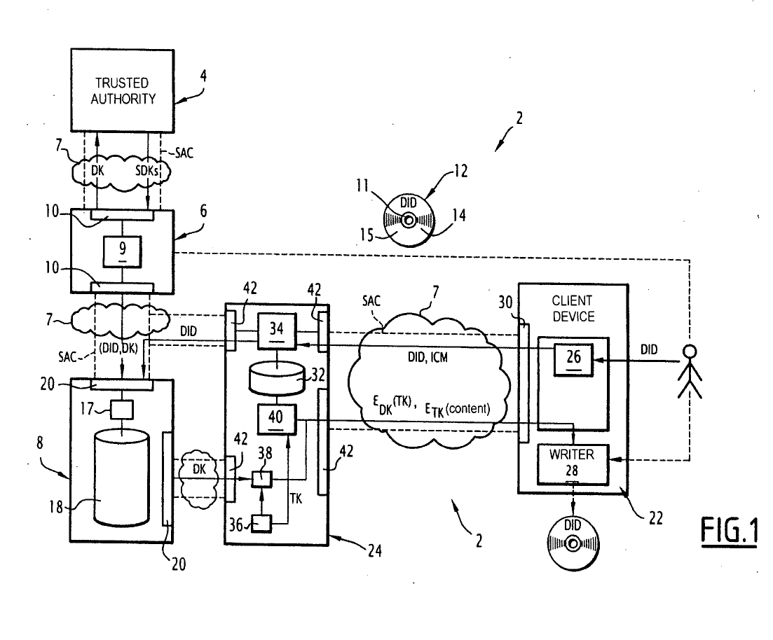

FIG. 1 is a schema in block functional form of the system allowing implementation of the methods according to the invention; and

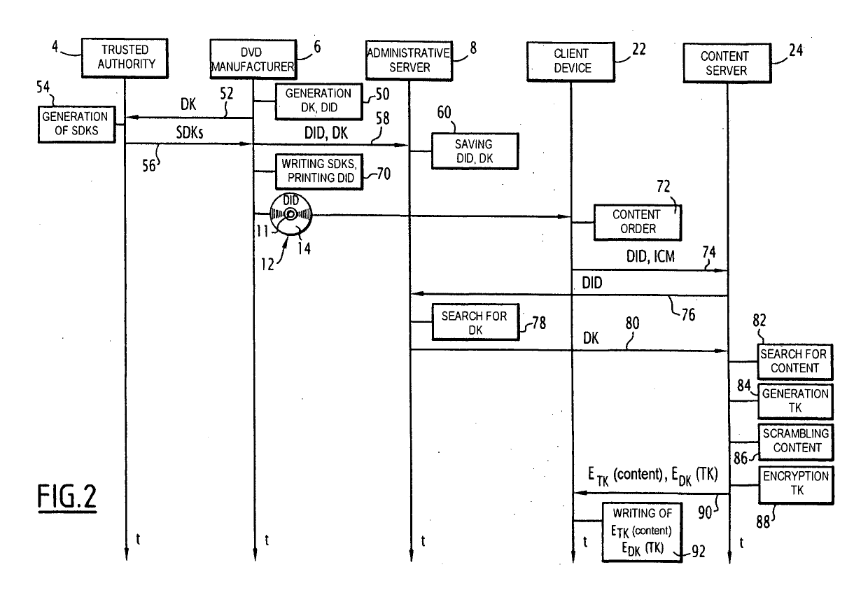

FIG. 2 is a schema illustrating the steps of the methods according to the invention.

In the remainder of the description reference is made solely to digital data representing multimedia content. But the invention can be applied to the distribution of any kind of content and in particular to sequences of audio, video or text data or to computer data files used for updating software.

The system 2 allowing implementation of the methods according to the invention is illustrated schematically in FIG. 1.

This system 2 comprises a trusted authority 4, a DVD disc manufacturer 6 and an administrative server 8 for disc keys DK, each designed to exchange data through a distribution network 7, such as through the Internet network for example.

In a conventional manner, the trusted authority 4 has the specific task of encrypting a disc key DK received from the DVD manufacturer 6 with the master keys MK specific to each DVD manufacturer in order to generate a set of secure disc keys SDKs corresponding to the encryption of the disc key DK.

The DVD manufacturer 6 includes a random number generator 9 and a network interface 10.

The generator 9 is able to generate identifiers DID in such a way that a unique identifier DID is associated with each DVD produced by the DVD manufacturer 6. The generator 9 is also able to generate disc keys DK in such a way that a unique disc key DK associated with this identifier DID and with the corresponding DVD corresponds to each identifier DID.

As a variant, it is possible to accept having several DIDs (and hence several DVDs) associated with a single disc key DK, if the probability of a user buying two DVDs with the same associated disc keys within a given period of time (e.g. a month) is low and if the probability of two users in the same geographical area acquiring DVDs with an identical associated disc key DK is also low. For example, a probability of less than 1% may be considered low. This allows the costs of the system to be reduced while preserving a high level of security.

The disc keys DK are independent of the identifiers DID with which they are associated such that it is impossible to deduce a disc key DK by applying a particular function to the identifier DID. In particular, the disc keys cannot be derived from a mathematical function applied to the identifier DID.

The DVD manufacturer 6 is designed to establish a secure connection, commonly called SAC (Secure Authenticated Channel) with the trusted authority 4 and the administrative disc key server 8.

The protocol for establishing a secure connection is, for example, a standard protocol such as the SSL (Secure Socket Layer) protocol or a proprietary protocol such as the protocol described in the specifications of the protection system with the registered trademark “Smart Right”, this protocol also being described in the U.S. patent application Ser. No. 10/978,162 filed on Oct. 29, 2004.

The DVD manufacturer 6 is able to transmit to the administrative disc key server 8 pairs, each comprising an identifier DID and a disc key DK associated with this identifier DID via a secure authenticated channel (SAC).

The DVD manufacturer 6 has the specific task of writing onto a lead-in area 11 of a DVD disc 12 the set of secure disc keys SDKs received from the trusted authority 4 in response to the sending of the disc key DK.

The DVD manufacturer 6 is designed to print on one 14 of the sides of the DVD disc 12, in a manner readable by a human user, the identifier DID associated with the encrypted disc key DK in order to obtain the set of the encrypted secure disc keys SDKs written onto this DVD disc 12.

A data area 15 of the DVD disc 12 is blank and may be written by the writer of a user, as explained below.

The administrative disc key server 8 comprises a processor 17 connected to a database 18 and to a network interface 20.

The processor 17 has the specific task of generating and completing the database 18 with the pairs, each comprising an identifier DID and a disc key DK associated with this identifier, transmitted by the DVD manufacturer 6.

The processor 17 is able to search in the database 18 for the disc key DK associated with an identifier DID in a given pair.

The processor 17 is able to send an alarm to the trusted authority 4 and not transmit the disc key DK when it receives an identifier DID that it has already received during a preceding request in order to spot a pirating problem.

The database 18 contains a look-up table for correspondence between the identifiers DID and the disc keys DK associated with these identifiers DID.

The administrative disc key server 8 is secure so as to ensure the confidentiality, availability and integrity of its database 18.

The system 2 furthermore comprises a client device 22 and a content-providing server 24.

The client device 22 is generally located with a user who wants access to multimedia content via the Internet network 7. It may be a computer, a digital decoder or a set top box.

This device has a human-machine interface 26 of the keyboard, screen and/or remote control type. It is connected to a legal and standard writer 28.

The client device 22 comprises a network interface 30 to receive streams of digital data from the Internet network, by downloading in real time (streaming), i.e. accessing content while loading, or by downloading in advance, i.e. accessing content at the end of downloading.

The client device 22 preferably also contains means for establishing a payment protocol with a financial intermediary or directly with the content-providing server 24. The payment protocols of the micropayment type, i.e. dedicated to payments of small sums, or the macropayment type for higher sums are well known to the person skilled in the art and will not be described further on.

The content-providing server 24 comprises a database 32 storing digital data representing multimedia content in a compressed form and a data processor 34 with the specific task of searching for ordered multimedia content in the database 32 based on a designation or a reference ICM from this.

The content-providing server 24 also comprises a random number generator 36 with the specific task of generating title keys TK, a module 38 for encrypting title keys TK and a module 40 for scrambling multimedia contents using title keys TK, both connected to the generator 36.

The data scrambling is preferably carried out according to the DVB CSS (Digital Video Broadcasting Content Scrambling System) standard.

The server furthermore comprises a network interface 42 connected to the processor 34, to the encryption module 38 and to the scrambling module 40.

The exchanges of data between the trusted authority 4, the DVD manufacturer 6, the administrative disc key server 8, the client device 22 and the content-providing server 24 are established only in the presence of a secure connection SAC.

The steps of the methods according to the invention are illustrated in FIG. 2 by five time axes t and by arrows illustrating the exchanges between the trusted authority 4, the DVD manufacturer 6, the administrative disc key server 8, the client device 22 and the content-providing server 24 along with the processes carried out by these devices.

In the course of a step 50, the DVD manufacturer 6 generates a disc key DK and an identifier DID associated with the disc key DK in order to produce a secure DVD disc 12.

In the course of a step 52, the DVD manufacturer 6 transmits the disc key DK to the trusted authority 4 through a secure authenticated channel (SAC).

In the course of a step 54, the trusted authority 4 encrypts the disc key DK received via the set of master keys MK from each of the manufacturers of DVD players in order to generate a set of secure disc keys SDKs.

In the course of a step 56, the trusted authority 4 transmits the set of secure disc keys SDKs thus obtained to the DVD manufacturer 6.

In the course of a step 58, the DVD manufacturer 6 transmits the disc key DK and the identifier DID associated with this disc key DK to the administrative disc key server 8.

In the course of a step 60, the processor 17 of the administrative server saves the disc key DK and the identifier DID in the database 18 in such a way that these are directly connected to allow recovery of the disc key DK on receiving the identifier DID.

In the course of a step 70, the DVD manufacturer 6 writes the set of secure disc keys SDKs onto the lead-in area 11 of the DVD disc 12 and prints the identifier DID on the side 14 of this DVD disc 12.

The DVD disc prerecorded in this way is distributed and sold commercially as a medium for secure recording of content.

When a user, having bought the secure DVD disc 12, wants to record on this multimedia content downloaded from a content-providing server 24, the user selects, by means of the interface 26 of the client device, a video sequence, for example a film or a particular program he wants to write onto the DVD disc 12.

In the course of a step 72, the user constructs, by means of the interface 26, a message ordering video content which he sends to the address of the content-providing server 24. This order message contains a reference ICM of the video sequence requested, a payment order along with the identifier DID printed on the DVD disc 12.

At the following step 74, the order message thus constructed is sent to the content-providing server 24.

In the course of a step 76, the content-providing server 24 transmits the identifier DID to the administrative server 8.

In the course of a step 78, the processor 17 of the administrative server searches for the disc key DK associated with the identifier DID received from the content-providing server 24.

In the course of a step 80, the administrative disc key server 8 transmits the disc key DK to the content-providing server 24.

In the course of a step 82, the processor 34 searches in the database 32 for the video sequence ordered by the user with the help of the reference ICM from this.

In the course of a step 84, the random number generator 36 generates title keys TK which it transmits to the encryption module 38 and to the scrambling module 40.

In the course of a step 86, the scrambling module 40 scrambles the video sequence coming from the database 32 using the title keys TK received from the generator 36.

In the course of a step 88, the encryption module 38 encrypts the title keys TK based on the disc key DK received from the administrative disc key server 8.

In the course of a step 90, the content-providing server 24 transmits the scrambled content using the title keys E_{TK}(content) and the title keys encrypted by the disc key E_{DK}(TK) to the client device. 22.

In the course of a step 92, the client device 22 receives the data transmitted by the content server, transmits them to the writer 28, which writes its data onto the data area 15 of the DVD disc 12.

As a variant, the identifier DID is prerecorded on an area of the blank DVD disc, for example in the form of an eight-bit number.

As a variant, the identifier DID is printed in the form of a barcode readable by a barcode reader of the client device.

As a variant, the identifier DID is printed on a document (label, sleeve etc.) associated with the DVD disc when sold.

As a variant, the identifier DID is transmitted directly by the client device 22 to the administrative disc key server 8 and does not pass through the content-providing server 24. In response, the administrative disc key server 8 transmits the disc key DK associated with this identifier DID to the content-providing server 24.

As a variant, the database 18 containing the identifier DID/disc key DK pairs is managed and contained in the content-providing server 24.

As a variant, each identifier DID is borne by each disc, i.e. it is necessarily written onto or printed on the disc. This embodiment offers greater protection as it avoids frauds through theft of the document associated with the disc.

As a variant, the identifier DID is generated by the trusted authority 4 rather than by the DVD manufacturer 6. As the trusted authority 4 has no financial link with the DVD manufacturer, the writer or the server providing multimedia content, this variant ensures that a single disc key DK corresponds to a unique identifier DID.

The method according to the invention has been described while using a CSS protection system. However, this method may also be used with a Vidi protection system as defined in the documents “Blue-ray Disc, Content Protection System for BD-Rom, White Paper, September 2003, Panasonic, Philips, Sony” and “Vidi Copy Protection System for DVD+R/+RW Video Recording Format, System Description, Version 1.0, March 2004, Philips, Hewlett-Packard”.

In this case, the DVD disc 12 is of the DVD-R/RW type, the disc key DK is a Vidi root key, the set of secure disc keys SDKs is an enabling key block, the manufacturer is a Vidi licensor, the trusted authority is the Vidi Rest Key Manager and finally the method of formatting the scrambled content is replaced by the Vidi formatting method.

As a variant, the DVD disc is of the DVD-R, DVD-RW, DVD+R, DVD+RW or DVD-RAM type.

Advantageously, the DVD disc thus obtained is secure by a standard protection format (for example CSS or Vidi) and may thus be read by all legal DVD players.

Advantageously, the secure DVD discs may be written by any existing DVD writer.

Advantageously, the secure DVD discs written according to the previously described method are resistant to bit-by-bit copying.

Advantageously, the disc key is not transmitted from the client device to the content-providing server, which ensures greater system security.

Advantageously, the protection of the encryption keys DK, TK is managed in a professional environment rather than by a client device. Consequently, the client device and the writer do not include any onboard encryption key, so that this solution is more secure than the existing solutions. Hence, this invention may be employed on existing video devices with minor modifications to obtain a secure written DVD disc.

Advantageously, the disc key administrator ensures diversification of the keys by managing its database, which allows dishonest DVD manufacturers to be checked.

Advantageously, the multimedia contents are delivered to the client device in a secure manner.

Advantageously, the content-providing server is independent of the representative of the protection format of the DVD disc.

Advantageously, different modes of distributing multimedia contents may be used, such as superdistribution or the use of the “push” mode.

Advantageously, the blank prewritten DVD discs may also be used as standard DVD discs which can be written normally without data protection.

1. A method for writing digital data coming from a remote content server the digital data being written onto a secure disc by a client device comprising the following steps carried out by the client device
gathering an identifier from the secure disc said identifier being associated with a first encryption key and with the secure disc on which the digital data are intended to be written, said identifier being specific to this secure disc and different from the identifiers associated with other secure discs
transmitting to the content server by means of a distribution network the secure disc identifier and a command to download digital data intended to be written onto the secure disc;
receiving digital data scrambled by at least one second encryption key and the or each second encryption key encrypted by a first encryption key the first encryption key being associated with the identifier in a database and
writing the scrambled digital data and the or each encrypted second encryption key onto the secure disc

2. The writing method as claimed in claim 1, wherein the identifier is printed in a way that can be read by a user on one side of the secure disc or on a document attached to the secure disc and wherein the gathering step includes a step of entering the identifier from by the user at the client device.

3. The writing method as claimed in claim 1, wherein the secure disc identifier the download command the scrambled digital data and the or each encrypted second encryption key are transmitted only during the establishment of a secure connection.

4. The writing method as claimed in claim 1, wherein the first encryption key is a disc key and the or each second encryption key is a title key in the sense of the CSS protection protocol.

5. The writing method as claimed in claim 1, wherein the first encryption key is independent of the identifier in the sense that it cannot be derived from a mathematical function applied to the identifier.

6. A method for making digital data available through a remote content server to at least one client device by means of a distribution network the digital data being intended to be written onto a secure by the client device which comprises the following steps carried out by the content server:
receiving an identifier and a command to download digital data from the client device said identifier being associated with a first encryption key and with the secure disc onto which the digital data are intended to be written, said identifier being specific to this secure disc and different from the identifiers associated with other secure discs;
acquiring the first encryption key associated with the identifier through a query to a database storing secure disc identifiers and first encryption keys associated with these identifiers;
searching for the digital data in a content database based on the download command;
generating at least one second encryption key;
scrambling the digital data searched for using the second encryption key(s) generated;
encrypting the second encryption key(s) based on the first encryption key; and
transmitting to the client device the digital data scrambled using the second encryption key(s) and the second encryption key(s) encrypted using the first encryption key.

7. A method for making data available as claimed in claim 6, wherein the step of acquiring the first encryption key comprises the following steps:
transmitting the identifier of the secure disc to an administrative disc key server containing the storage database; and
receiving the first encryption key associated with the secure disc identifier from the administrative disc key server.

8. A content server suited to making digital data available to at least one client device by means of a distribution network, the digital data being intended to be written onto a secure disc, which comprises:
a network interface for receiving an identifier and a command to download digital data transmitted by the client device said identifier being associated with a first encryption key and with the secure disc on which the digital data are intended to be written, said identifier being specific to this secure disc and different from the identifiers associated with other secure discs;
means for searching for digital data intended to be written in a content database based on the download command transmitted by the client device;
a random number generator suited to generating at least one second encryption key;
means for scrambling digital data intended to be written using the second encryption key(s) generated;
means for acquiring the first encryption key associated with the identifier through a query to a database storing secure disc identifiers and first encryption keys associated with these identifiers;
means of encrypting the second encryption key(s) based on the first encryption key; and
the network interface being able to transmit the digital data scrambled using the second encryption key(s) and the second encryption key(s) encrypted using the first encryption key to the client device.

9. A method for distributing digital data via a remote content server to at least one client device by means of a distribution network, the digital data being intended to be written onto a secure disc, which comprises the following steps:
gathering through the client device an identifier from the secure disc said identifier being associated with a first encryption key and with the secure disc on which the digital data are intended to be written, said identifier being specific to this secure disc and different from the identifiers associated with other secure discs;
transmitting the secure disc identifier and a command to download digital data intended to be written onto the secure disc from the client device to the content server by means of a distribution network;
searching, by the content server, for the digital data in a content database based on the download command;
generating by the content server at least one second encryption key;
scrambling by the content server the digital data searched for using the second encryption key(s);
acquiring the first encryption key associated with the secure disc identifier through a query by the content server to a database storing secure disc identifiers and first encryption keys associated with these identifiers;
encrypting by the content server the second encryption key(s) based on the first encryption key;
transmitting from the content server to the client device the digital data scrambled using the second encryption key(s) and the second encryption key(s) encrypted using the first encryption key; and
writing onto the secure disc the scrambled digital data (E_{TK}(content)) and the encrypted second encryption key(s) by the client device.
